(19) United States
(12) Patent Application Publication
(10) Pub. No.: US 2020/0311549 A1
(43) Pub. Date: Oct. 1, 2020

(54) METHOD OF PRUNING CONVOLUTIONAL NEURAL NETWORK BASED ON FEATURE MAP VARIATION

(71) Applicant: Xilinx, Inc., San Jose, CA (US)

(72) Inventors: Yu WANG, Beijing (CN); Fan JIANG, Beijing (CN); Xiao SHENG, Beijing (CN); Song HAN, Beijing (CN); Yi SHAN, Beijing (CN)

(21) Appl. No.: 16/759,316

(22) PCT Filed: May 16, 2018
(86) PCT No.: PCT/CN2018/087135

§ 371 Date: Apr. 24, 2020

(30) Foreign Application Priority Data
Oct. 26, 2017 (CN) 201711011383.2

(51) Int. Cl. G06N 3/08; G06N 3/04

(52) U.S. Cl. CPC G06N 3/082; G06N 3/04

(57) ABSTRACT

Provided in the present disclosure is a method of pruning a convolutional neural network based on feature map variation. The present invention enables compression of an entire network by means of removing a portion of filters in a convolutional layer, and such process is called pruning. A main contribution of the present invention is determining a pruning rule for filters in a single convolutional layer according to a feature map variation condition, using the rule to analyze network sensitivity, and pruning the entire network according to the network sensitivity.

### TECHNICAL FIELD

The present disclosure relates to artificial neural network, in particular to pruning a Convolution Neural Network based on feature map variation.

### BACKGROUND

In recent years, with the development of Deep Learning technology, Artificial Neural Networks (ANN) has been used in more and more fields. Convolution Neural Network (CNN) is a representative network structures, which is applied in image processing, speech recognition, natural language processing and other fields. Especially in image processing, thanks to the deepening of network structure, Convolution Neural Network has achieved great success. At the same time, the deepening of the network also increases computing resources required for network training and reasoning, which greatly limits application scenarios of Convolution Neural Network.

Therefore, related technologies of neural network compression become more and more important. Common network compression techniques include pruning, quantization, distilling and so on.

### SUMMARY

The method proposed by the present disclosure is a kind of pruning technology, in which by removing some “connections” in the network, amount of parameters and amount of computation required by a model can be effectively reduced.

The present disclosure provides a method for pruning a Convolution Neural Network based on feature map variation.

According to a first aspect of the present disclosure, it is provided a method for pruning filters in a convolution layer based on feature map variation in a Convolution Neural Network, wherein for an i^{th} convolution layer containing n filters, m filters are expected to be removed, the method comprises: (1) performing a forward computation on an original neural network model, to get a feature map x generated by the (i+k)^{th} convolution layer, where k is any positive integer; (2) traversing all of the n filters in the i^{th} convolution layer; (3) removing a j^{th} filter currently traversed in which remaining filters are the same as in the original network model, to generate a new model; (4) performing a forward computation on the new model, to get a feature map x′ generated by the (i+k)^{th} convolution layer; (5) calculating a difference value of the feature maps between x and x′; (6) after traversing all of the n filters, sorting the n filters according to difference values of the feature maps between x and x′; (7) selecting m filters with smallest difference values of the feature maps, as filters to be removed.

Preferably, k=2.

Preferably, difference values of the feature maps between x and x′ is a L2 norm of difference values of the feature maps between x and x′, recorded as diffⱼ=∥x−x′∥₂.

According to a second aspect of the present disclosure, it is provided a method for performing network sensitivity analysis by pruning filters in a convolution layer in a Convolution Neural Network, comprising: for an original network model, testing accuracy thereof by a validation dataset; traversing all of the convolution layers except the last k convolution layers in the network, where k is any positive integer; performing the steps (1) to (6) of the method of pruning filters in a convolution layer based on feature map variation in a Convolution Neural Network as described in the first aspect of the present disclosure on a convolution layer currently traversed; removing each filter sequentially from a filter with the smallest difference value, wherein whenever a filter is removed, accuracy of a network after pruning is tested, until a last filter is left, to get a testing result {acc₀, acc₁, acc₂, . . . , accₙ₋₂} of the accuracy of the network; restoring all filters that have been removed in current convolution layer, with keeping same as the original network; calculating difference values between the testing result {acc₀, acc₁, acc₂, . . . , accₙ₋₂} of the accuracy of the network and accuracy of the original network, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

According to the third aspect of the present disclosure, it is provided a method for pruning a network based on sensitivity in a Convolution Neural Network, comprising: performing the method for performing network sensitivity analysis by pruning filters in a convolution layer in a Convolution Neural Network as in the second aspect of the present disclosure; setting a loss threshold of model accuracy that is acceptable after pruning; traversing all of the convolution layers except the last k convolution layers in the network, where k is any positive integer, and according to sensitivity result of a convolution layer currently traversed, determining a maximum number m of filters that are removable in the layer under the condition that the loss threshold of model accuracy is not exceeded; removing m filters of the layer with smallest sorted difference values of the feature maps; after traversing all of the convolution layers except the last k convolution layers in the network, completing the pruning on these layers.

According to a fourth aspect of the present disclosure, it is provided computer-readable medium for recording instructions that can be executed by a processor, that when executed by the processor, cause the processor to perform a method for pruning filters in a convolution layer based on feature map variation in a Convolution Neural Network, wherein for an i^{th} convolution layer containing n filters, m filters are expected to be removed, comprises the following operations: (1) performing a forward computation on an original neural network model, to get a feature map x generated by the (i+k)^{th} convolution layer, where k is any positive integer; (2) traversing all of the n filters in the i^{th} convolution layer; (3) removing a j^{th} filter currently traversed in which remaining filters are the same as in the original network model, to generate a new model; (4) performing a forward computation on the new model, to get a feature map x′ generated by the (i+k)^{th} convolution layer; (5) calculating a difference value of the feature maps between x and x′; (6) after traversing all of the n filters, sorting the n filters according to difference values of the feature maps between x and x′; (7) selecting m filters with smallest difference values of the feature maps, as filters to be removed.

According to a fifth aspect of the present disclosure, it is provided computer-readable medium for recording instructions that can be executed by a processor, that when executed by the processor, cause the processor to perform a method for performing network sensitivity analysis by pruning filters in a convolution layer in a Convolution Neural Network, comprising: for an original network model, testing accuracy thereof by a validation dataset; traversing all of the convolution layers except the last k convolution layers in the network, where k is any positive integer; performing the steps (1) to (6) of the method of pruning filters in a convolution layer based on feature map variation in a Convolution Neural Network as described in the first aspect of the present disclosure on a convolution layer currently traversed; removing each filter sequentially from a filter with the smallest difference value, wherein whenever a filter is removed, accuracy of a network after pruning is tested, until a last filter is left, to get a testing result {acc₀, acc₁, acc₂, . . . , accₙ₋₂} of the accuracy of the network; restoring all filters that have been removed in current convolution layer, with keeping same as the original network; calculating difference values between the testing result {acc₀, acc₁, acc₂, . . . , accₙ₋₂} of the accuracy of the network and accuracy of the original network, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

According to a sixth aspect of the present disclosure, it is provided computer-readable medium for recording instructions that can be executed by a processor, that when executed by the processor, cause the processor to perform a method for pruning a network based on sensitivity in a Convolution Neural Network, comprising: performing the method for performing network sensitivity analysis by pruning filters in a convolution layer in a Convolution Neural Network as in the fifth aspect of the present disclosure; setting a loss threshold of model accuracy that is acceptable after pruning; traversing all of the convolution layers except the last k convolution layers in the network, where k is any positive integer, and according to sensitivity result of a convolution layer currently traversed, determining a maximum number m of filters that are removable in the layer under the condition that the loss threshold of model accuracy is not exceeded; removing m filters of the layer with smallest sorted difference values of the feature maps; after traversing all of the convolution layers except the last k convolution layers in the network, completing the pruning on these layers.

The present disclosure realizes compression of the whole network by removing portion of the filters in the convolution layer, this process of which is called pruning. Main contribution of the present disclosure is to determine a pruning criterion of the filter in a single convolution layer according to the feature map variation, analyze sensitivity of the network by using the criterion, and finally performing pruning on the whole network according to the sensitivity of the network.

### BRIEF DESCRIPTION OF THE DRAWINGS

The present disclosure is illustrated with reference to the figures and embodiments below. In the accompanying figures:

FIG. 1 is a schematic diagram of performing forward computation based on an original neural network.

FIG. 2 is a schematic diagram of performing forward computation after a filter has been removed.

FIG. 3 is a flowchart of a method of pruning filters in a convolution layer based on feature map variation in a Convolution Neural Network according to the present disclosure.

FIG. 4 is a flowchart of a method for performing network sensitivity analysis by pruning filters in a convolution layer in a Convolution Neural Network according to the present disclosure.

FIG. 5 is a flowchart of a method of performing pruning on network in a Convolution Neural Network based on sensitivity according to the present disclosure.

### DETAILED DESCRIPTION

The accompanying figures are for illustration only and cannot be understood as a limitation to the present disclosure. The technical solution of the present disclosure will be further explained in combination with the figures and embodiments below.

The Convolution Neural Network (CNN) is mainly composed of a series of connected convolution layers, wherein a convolution layer also contains a number of filters. The present disclosure realizes compression of the whole network by removing portion of the filters in the convolution layer, this process of which is called pruning. Main contribution of the present disclosure is to determine a pruning criterion of the filter in a single convolution layer according to the feature map variation, analyze sensitivity of the network by using the criterion, and finally perform pruning on the whole network according to the sensitivity of the network.

Pruning Criterion Based on the Feature Map Variation

Convolution Neural Network is composed from connecting continuous convolution layers, which are numbered as 0, 1, 2, . . . , in order from input to output. The convolution layer generates several feature maps after performing convolution operation on input data, and the feature maps enter next convolution layer as input data after activation, pooling and other operations. Pruning is a process of removing portion of filters of the convolution layer. The present disclosure provides a method for selecting the filters to be removed based on the feature map variation, that is, the pruning criterion.

According to a preferred embodiment of the present disclosure, it is assumed that the i^{th} convolution layer contains n filters, and it is expected to remove m filters therefrom. In the preferred embodiment, on which filters removing operation will be performed is determined by calculating the feature map variation of the (i+2)^{th} convolution layer. The specific process is as follows:

1. performing a forward computation on the original neural network model, and storing a feature map generated by the (i+2)^{th} convolution layer, recorded as x, as shown in FIG. 1 which is a schematic diagram of performing forward computation based on the original neural network;

2. traversing filters in the i^{th} convolution layer, removing i^{th} filter currently traversed, with remaining filters being same as in the original network model, to generate a new model;

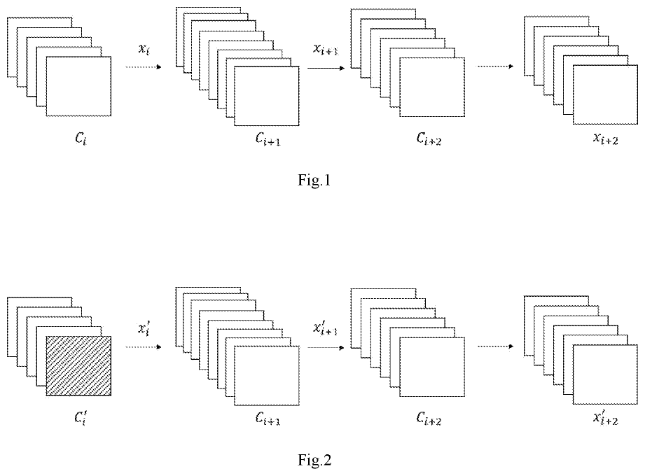

3. performing a forward computation on the new model, to get a feature map generated by the (i+2)^{th} convolution layer, which is recorded as x′, as shown in FIG. 2 which is a schematic diagram of performing forward computation after a filter has been removed;

4. calculating L2 norm (L2Norm) of the difference value between x and x′, that is, diffⱼ=∥x-x′∥₂;

5. performing steps 2 to 4 repeatedly, until all filters in the layer have been traversed;

6. sorting the filters by diff values;

7. selecting m filters with the smallest diff values, as filters that need to be removed finally.

It should be noted by those skilled in the art that, although in the above preferred embodiment, the feature map generated by the (i+2)^{th} convolution layer is recorded, and by sorting the difference values from the feature map generated by the layer, removal order of the filters in the i^{th} convolution layer is determined the method can be applied to feature map generated by the (i+k)^{th} convolution layer, and by sorting the difference values from the feature map generated by the layer, removal order of the filters in the i^{th} convolution layer is determined, where k is any positive integer. However, in the process of implementation, those skilled in the art will certainly be able to find an appropriate value of k (e.g., k=2 in a preferred embodiment), so that difference value thus calculated can best reflect importance of the filters and sensitivity that will be mentioned later.

In addition, the above preferred embodiment adopts the L2 norm in calculating the difference value between x and x′, that is, diffⱼ=∥x−x′∥₂. However, those skilled in the art should understand that other spatial or conceptual difference values can also be applied here, as long as they can reflect differences between feature maps, can be used to get magnitude of the differences by comparing.

Based on the above preferred embodiments, a method of pruning filters in the convolution layer based on feature map variation in the Convolution Neural Network according to the present disclosure will be described below.

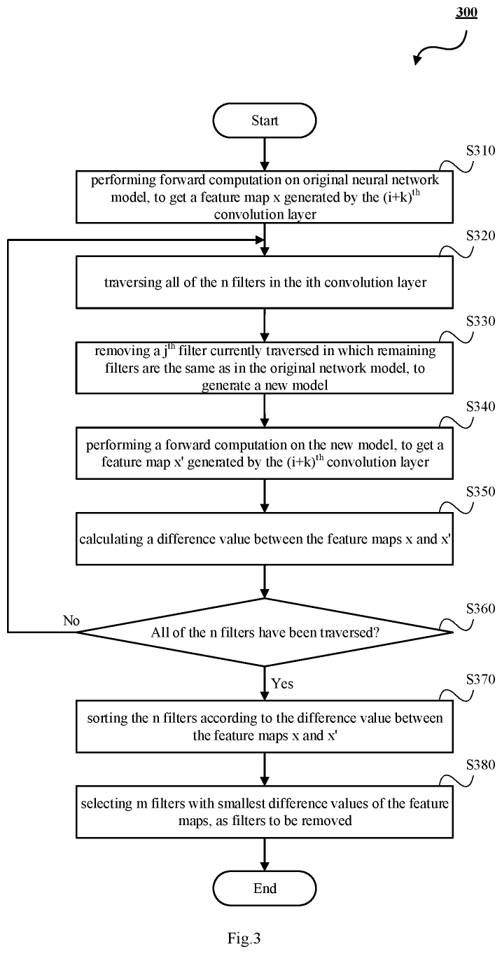

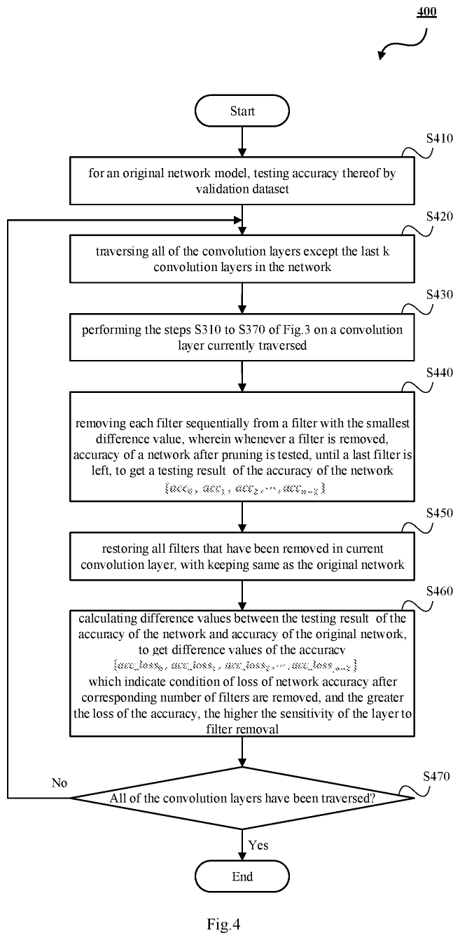

FIG. 3 is a flowchart of a method of pruning filters in a convolution layer based on feature map variation in a Convolution Neural Network according to the present disclosure.

Since it is a general method, following settings are made in the method in FIG. 3: in the Convolution Neural Network, for the i^{th} convolution layer containing n filters, m filters are expected to be removed therefrom.

As shown in FIG. 3, the method 300 for pruning the filters in the convolution layer based on the feature map variation in the Convolution Neural Network according to the present disclosure starts with step S310 of performing a forward computation on an original neural network model, to get a feature map x generated by the (i+k)^{th} convolution layer, where k is any positive integer. As described above, value of k here may be taken as k=2 in a preferred embodiment.

Next, starting from step S320, all of n filters in the i^{th} convolution layer are traversed.

In step S330, the j^{th} filter currently traversed is removed, and remaining filters are same as the original network model, to generate a new model.

Next, in step S340, a forward computation is performed on the new model, and a feature map x′ generated by the (i+k)^{th} convolution layer is obtained.

In step S350, a difference value of feature maps between x and x′ is calculated. In a preferred embodiment of the present disclosure, the difference value of feature maps between x and x′ refers to the L2 norm of the difference value of the feature maps between x and x′, which is recorded as diffⱼ=∥x−x′∥₂.

In step S360, it is determined whether all of n filters have been traversed.

If the determination result of step S360 is negative, that is, there is still a filter that has not been traversed, then the method returns to step S320 (“No” branch of step S360), to continue traversing filters in the convolution layer, and execute steps S330 to S360.

On the other hand, if the determination result of step S360 is positive, that is, all of n filters have been traversed, the method 300 proceeds to step S370 (“Yes” branch of step S360) where the n filters are sorted by the difference values of the feature maps between x and x′.

Finally, in step S380, m filters with the smallest difference values of the feature maps are selected as the filters to be removed. After that, the pruning method or pruning criterion 300 can end.

Sensitivity Analysis Using Pruning Criterion

The Convolution Neural Network model is getting deeper currently, and often contains a lot of convolution layers. For the convolution layer, given the number m of filters expected to be removed, m filters can be selected by using the above pruning criterion. The problem is that for each convolution layer, number of filters, dimension of the convolution kernel, and its position in the model are different. It is not easy to determine the number m of filters to be removed for each convolution layer. The present disclosure uses the pruning criterion proposed above to analyze sensitivity of each convolution layer, so as to determine sensitivity of each convolution layer to filter removal, to provide a basis for subsequent pruning of the whole network.

According to a preferred embodiment of the present disclosure, the method of sensitivity analysis using pruning criterion is as follows:

1. for the original network model, testing the accuracy of the original network model by using the verification dataset;

2. traversing each convolution layer in the network, performing steps 1 to 6 of the pruning criterion on convolution layer currently traversed, i.e., steps S310 to S370 in the method 300 of FIG. 3, that is, all steps before final selection of pruning objects;

3. according to sorted diff values of the filters, removing each filter in order from the filter with the smallest diff, wherein whenever a filter is removed, accuracy of a network after pruning is tested, until a last filter is left, to get {acc₀, acc₁, acc₂, . . . , accₙ₋₂};

4. restoring all filters that have been removed in current convolution layer, with keeping same as the original network;

5. calculating difference values between the accuracy {acc₀, acc₁, acc₂, . . . , accₙ₋₂} of the network after removing the filters and the accuracy of the original network, to get {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

6. repeating steps 2 to 4 of this method, until all convolution layers in the network have been traversed.

It should be noted here that in the pruning criterion of the present disclosure, when considering the pruning of the filters of the i^{th} convolution layer, the (i+k)^{th} convolution layer needs to be obtained (in a preferred embodiment of the present disclosure, k=2). Therefore, in the sensitivity analysis, for the last k convolution layers, the pruning criterion of the present disclosure cannot be used for sensitivity analysis, because there is no (i+k)^{th} convolution layer in this case. In this case, for the pruning method of the convolution layer, there can be different means in practice according to specific situation. For example, the simplest way is to skip without pruning; or sorting can be performed according to sum of absolute weight of each filter in the convolution core to decide which filters to be removed. For the method for sensitivity analysis, the sensitivity analysis can be omitted therefor, that is, in the traversal process of the present disclosure, it is aimed at all convolution layers in the network except the last k convolution layers; on the other hand, other pruning criterion can be used for the last k convolution layers (for example, determining by the sum of the absolute values of weights as mentioned above) to perform sorting, thus the sensitivity analysis can be carried out.

Based on the above preferred embodiments, a method for performing network sensitivity analysis in a Convolution Neural Network by pruning filters in convolution layers according to the present disclosure will be described below.

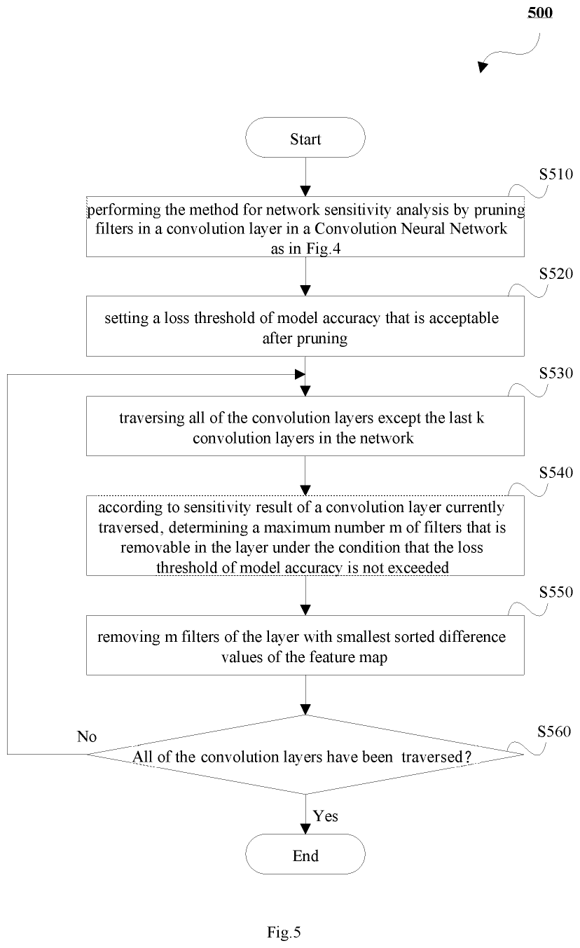

FIG. 4 is a flowchart of a method for performing network sensitivity analysis by pruning filters in a convolution layer in a Convolution Neural Network according to the present disclosure.

Since it is a general method and refers to some steps in FIG. 3, the method in FIG. 4 follows the setting in FIG. 3: in the Convolution Neural Network, for the i^{th} convolution layer containing n filters, m filters are expected to be removed.

As shown in FIG. 4, the method 400 of the present disclosure for network sensitivity analysis in a Convolution Neural Network by pruning filters in convolution layers starts with step S410 in which for the original network model, its accuracy is tested using a verification dataset.

Next, starting from step S420, traversing all of the convolution layers except the last k convolution layers in the network, where k is any positive integer.

In step S430, the operations of steps S310 to S370 in the pruning method 300 in FIG. 3 is performed on the convolution layer currently traversed. Specifically, it includes the following operations:

(1) performing a forward computation on the original neural network model, to get a feature map x generated by the (i+k)^{th} convolution layer, where k is any positive integer;

(2) traversing all of the n filters in the i^{th} convolution layer;

(3) removing a j^{th} filter currently traversed in which remaining filters are the same as in the original network model, to generate a new model;

(4) performing a forward computation on the new model, to get a feature map x′ generated by the (i+k)^{th} convolution layer;

(5) calculating a difference value of the feature maps between x and x′;

(6) after traversing all of the n filters, sorting the n filters according to difference values of the feature maps between x and x′.

Next, in step S440, each filter sequentially from a filter with the smallest difference value is removed, wherein whenever a filter is removed, accuracy of a network after pruning is tested, until a last filter is left, to get a testing result {acc₀, acc₁, acc₂, . . . , accₙ₋₂} of the accuracy of the network;

Then, in step S450, all filters that have been removed in current convolution layer is restored, with keeping same as the original network;

According to the method 400 of the present disclosure, in step S460, difference values between the testing result {acc₀, acc₁, acc₂, . . . , accₙ₋₂} of the accuracy of the network and accuracy of the original network is calculated, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

Finally, in step S470, it is determined whether all convolution layers have been traversed (except the last k convolution layers).

If the determination result of step S470 is negative, that is, there is still a convolution layer that has not been traversed, the method returns to step S420 (“No” branch of step S470), to continue traversing convolution layer, and execute steps S430 to S470.

On the other hand, if the determination result of step S470 is positive, that is, all convolution layers have been traversed (except the last k convolution layers), then method 400 can end.

Pruning the Network Based on the Sensitivity Result

With the sensitivity result, sensitivity of each convolution layer to filter removal can be known. For convolution layer with lower sensitivity, more filters can be removed; for convolution layer with higher sensitivity, fewer filters or no filter may be removed. In the present disclosure, based on acceptable loss of accuracy after pruning, the number of filters to be removed from each convolution layer is calculated, to realize the pruning of the whole network. The details are as follows:

1. performing the method for sensitivity analysis as described above;

2. setting an accuracy loss of model that is acceptable after pruning;

3. traversing all of the convolution layers, according to sensitivity result of the layer, determining a maximum number m of filters that are removable in the layer under the condition that the accuracy loss of model is not exceeded;

4. removing first m filters after sorted by diff values in the layer;

5. repeating steps 3 to 4 of the method until all convolution layers are pruned.

As mentioned earlier, it is also necessary to note here that in the pruning criterion of the present disclosure, when considering the pruning of the filters of the i^{th} convolution layer, the (i+k)^{th} convolution layer needs to be obtained (in a preferred embodiment of the present disclosure, k=2). Therefore, in the sensitivity analysis, for the last k convolution layers, the pruning criterion of the present disclosure cannot be used for sensitivity analysis, because there is no (i+k)^{th} convolution layer in this case. In this case, for the pruning method of the convolution layer, there can be different means in practice according to specific situation. For example, the simplest way is to skip without pruning; sorting can also be performed according to sum of absolute weight of each filter in the convolution core to decide which filters to be removed. For the method of pruning network based on the sensitivity result, sensitivity analysis can be omitted, that is, in the traversal process of the present disclosure, it is aimed at all convolution layers in the network except the last k convolution layers; on the other hand, other pruning criterion can be used for the last k convolution layers (for example, determining by the sum of the absolute values of weights as mentioned above) to perform sorting, thus the sensitivity analysis and pruning can be carried out, or pruning can be carried out directly.

Based on the above preferred embodiments, a method of performing pruning on network in a Convolution Neural Network based on sensitivity according to the present disclosure will be described below.

FIG. 5 is a flowchart of a method of performing pruning on network in a Convolution Neural Network based on sensitivity according to the present disclosure.

Since it is a general method and refers to the steps in FIG. 4, which refers to some of the steps in FIG. 3, the method in FIG. 5 follows the setting in FIG. 3: in the Convolution Neural Network, for the i^{th} convolution layer containing n filters, m filters are expected to be removed.

As shown in FIG. 5, the method 500 of performing pruning on network in a Convolution Neural Network based on sensitivity according to the present disclosure starts with step S510, in which the method 400 of FIG. 4 for network sensitivity analysis in a Convolution Neural Network by pruning filters in convolution layers is performed. That is, in step S510, all steps in method 400 are performed: steps S410 to step S470.

Next, in step S520, a loss threshold of model accuracy that is acceptable after pruning is set;

Starting from step S530, all convolution layers in the network except the last k convolution layers are traversed, where k is any positive integer.

In step S540, according to sensitivity result of a convolution layer currently traversed, a maximum number m of filters that are removable in the layer under the condition that the loss threshold of model accuracy is not exceeded is determined;

Then, in step S550, m filters of the layer with smallest sorted difference values of the feature maps are removed;

Finally, in step S560, it is determined whether all convolution layers have been traversed (except the last k convolution layers).

If the determination result of step S560 is negative, that is, there is still a convolution layer that has not been traversed, then the method returns to step S530 (“No” branch of step S560), to continue traversing convolution layer, and execute steps S540 to S560.

On the other hand, if the determination result of step S560 is positive, that is, all convolution layers have been traversed (except the last k convolution layers), then pruning of these layers has been completed, that is, the method 500 ends.

Those skilled in the art should realize that the method of the present disclosure can be realized as a computer program. As described above in conjunction with FIG. 3 the method according to the above embodiment may execute one or more programs including instructions to cause the computer or processor to execute the algorithm described in conjunction with the figures. These programs can be stored and provided to a computer or processor using various types of non-instantaneous computer-readable media. Non-instantaneous computer-readable media include various types of tangible storage media. Examples of non-instantaneous computer-readable media include magnetic recording media (such as floppy disks, magnetic tapes, and hard disk drives), magneto-optical recording media (such as magneto-optical discs), CD-ROM (compact disk read-only memory), CD-R, CD-R/W, and semiconductor memories (such as ROM, PROM (programmable ROM), EPROM (rewritable PROM), flash ROM and RAM (random access memory). Further, these programs can be provided to the computer by using various types of instantaneous computer-readable media. Examples of instantaneous computer-readable media include electrical signals, optical signals, and electromagnetic waves. The instantaneous computer-readable medium may be used to provide a program to a computer through a wired communication path or a wireless communication path, such as wires and optical fibers.

Therefore, according to the present disclosure, it is also possible to propose a computer program or a computer-readable medium for recording instructions that can be executed by a processor, that when executed by the processor, cause the processor to perform a method for pruning filters in a convolution layer based on feature map variation in a Convolution Neural Network, wherein for an i^{th} convolution layer containing n filters, m filters are expected to be removed, comprising following operations: (1) performing a forward computation on an original neural network model, to get a feature map x generated by the (i+k)^{th} convolution layer, where k is any positive integer; (2) traversing all of the n filters in the i^{th} convolution layer; (3) removing a j^{th} filter currently traversed in which remaining filters are the same as in the original network model, to generate a new model; (4) performing a forward computation on the new model, to get a feature map x′ generated by the (i+k)^{th} convolution layer; (5) calculating a difference value of the feature maps between x and x′; (6) after traversing all of the n filters, sorting the n filters according to difference values of the feature maps between x and x′; (7) selecting m filters with smallest difference values of the feature maps, as filters to be removed.

In addition, according to the present disclosure, a computer program or a computer-readable medium can be proposed for recording instructions that can be executed by a processor, that when executed by the processor, cause the processor to perform a method for performing network sensitivity analysis by pruning filters in a convolution layer in a Convolution Neural Network, comprising: for an original network model, testing accuracy thereof by a validation dataset; traversing all of the convolution layers except the last k convolution layers in the network, where k is any positive integer; performing the steps (1) to (6) of the method of pruning filters in a convolution layer based on feature map variation in a Convolution Neural Network according to the present disclosure on a convolution layer currently traversed; removing each filter sequentially from a filter with the smallest difference value, wherein whenever a filter is removed, accuracy of a network after pruning is tested, until a last filter is left, to get a testing result {acc₀, acc₁, acc₂, . . . , accₙ₋₂} of the accuracy of the network; restoring all filters that have been removed in current convolution layer, with keeping same as the original network; calculating difference values between the testing result {acc₀, acc₁, acc₂, . . . , accₙ₋₂} of the accuracy of the network and accuracy of the original network, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

In addition, according to the present disclosure, a computer program or a computer-readable medium may be proposed for recording instructions that can be executed by a processor, that when executed by the processor, cause the processor to perform a method for pruning a network based on sensitivity in a Convolution Neural Network, comprising following operations: performing the method for performing network sensitivity analysis by pruning filters in a convolution layer in a Convolution Neural Network according to the present disclosure; setting a loss threshold of model accuracy that is acceptable after pruning; traversing all of the convolution layers except the last k convolution layers in the network, where k is any positive integer, according to sensitivity result of a convolution layer currently traversed, determining a maximum number m of filters that are removable in the layer under the condition that the loss threshold of model accuracy is not exceeded; removing m filters of the layer with smallest sorted difference values of the feature maps; after traversing all of the convolution layers except the last k convolution layers in the network, completing the pruning on these layers.

Various embodiments and situations of the present disclosure have been described above. However, the spirit and scope of the present disclosure are not limited to this. Those skilled in the art will be able to make more applications according to the teachings of the present disclosure, and these applications are within the scope of the present disclosure.

That is, the above embodiments of the present disclosure are only for the purpose of clearly illustrating the examples made by the present disclosure, rather than limiting the embodiments of the present disclosure. For ordinary technicians in their field, other different forms of changes or changes can be made on the basis of the above instructions. There is no need and no exhaustion of all the implementation methods here. Any modification, replacement or improvement made within the spirit and principles of the present disclosure shall be included in the scope of protection claimed by the present disclosure.

1. A method for pruning filters in a convolution layer based on feature map variation in a Convolution Neural Network, wherein for an i^{th} convolution layer containing n filters, m filters are expected to be removed, the method comprising:
(1) performing a forward computation on an original neural network model, to get a feature map x generated by the (i+k)^{th} convolution layer, where k is any positive integer;
(2) traversing all of the n filters in the i^{th} convolution layer;
(3) removing a j^{th} filter currently traversed in which remaining filters are the same as in the original network model, to generate a new model;
(4) performing a forward computation on the new model, to get a feature map x′ generated by the (i+k)^{th} convolution layer;
(5) calculating a difference value of the feature maps between x and x′;
(6) after traversing all of the n filters, sorting the n filters according to difference values of the feature maps between x and x′;
(7) selecting m filters with smallest difference values of the feature maps, as filters to be removed.

2. The method as in claim 1, wherein k=2.

3. The method as in claim 1, wherein the difference value of the feature maps between x and x′ is a L2 norm of the difference value of the feature maps between x and x′, recorded as diffⱼ=∥x−x′∥₂.

4. A method for performing network sensitivity analysis by pruning filters in a convolution layer in a Convolution Neural Network, comprising:
for an original network model, testing accuracy thereof by a validation dataset;
traversing all of the convolution layers except the last k convolution layers in the network, where k is any positive integer;
performing the steps (1) to (6) of the method of pruning filters in a convolution layer based on feature map variation in a Convolution Neural Network as described in claim 1 on a convolution layer currently traversed;
removing each filter sequentially from a filter with the smallest difference value, wherein whenever a filter is removed, accuracy of a network after pruning is tested, until a last filter is left, to get a testing result {acc₀, acc₁, acc₂, acc₂, . . . , accₙ₋₂} of the accuracy of the network;
restoring all filters that have been removed in current convolution layer, with keeping same as the original network;
calculating difference values between the testing result {acc₀, acc₁, acc₂, . . . , accₙ₋₂} of the accuracy of the network and accuracy of the original network, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

5. A method for pruning a network based on sensitivity in a Convolution Neural Network, comprising:
perform the method for performing network sensitivity analysis by pruning filters in a convolution layer in a Convolution Neural Network as in claim 4;
setting a loss threshold of model accuracy that is acceptable after pruning;
traversing all of the convolution layers except the last k convolution layers in the network, where k is any positive integer, according to sensitivity result of a convolution layer currently traversed, determining a maximum number m of filters that are removable in the layer under the condition that the loss threshold of model accuracy is not exceeded;
removing m filters of the layer with smallest sorted difference values of the feature maps;
after traversing all of the convolution layers except the last k convolution layers in the network, completing the pruning on these layers.

6. A computer-readable medium for recording instructions that can be executed by a processor, that when executed by the processor, cause the processor to perform a method for pruning filters in a convolution layer based on feature map variation in a Convolution Neural Network, wherein for an i^{th} convolution layer containing n filters, m filters are expected to be removed, the method comprising:
(1) performing a forward computation on an original neural network model, to get a feature map x generated by the (i+k)^{th} convolution layer, where k is any positive integer;
(2) traversing all of the n filters in the i^{th} convolution layer;
(3) removing a j^{th} filter currently traversed in which remaining filters are the same as in the original network model, to generate a new model;
(4) performing a forward computation on the new model, to get a feature map x′ generated by the (i+k)^{th} convolution layer;
(5) calculating a difference value of the feature maps between x and x′;
(6) after traversing all of the n filters, sorting the n filters according to the difference values of the feature maps between x and x′;
(7) selecting m filters with smallest difference values of the feature maps, as filters to be removed.

7. A computer-readable medium for recording instructions that can be executed by a processor, that when executed by the processor, cause the processor to perform a method for performing network sensitivity analysis by pruning filters in a convolution layer in a Convolution Neural Network, comprising:
for an original network model, testing accuracy thereof by a validation dataset;
traversing all of the convolution layers except the last k convolution layers in the network, where k is any positive integer;
performing the steps (1) to (6) of the method of pruning filters in a convolution layer based on feature map variation in a Convolution Neural Network as described in claim 1 on a convolution layer currently traversed;
removing each filter sequentially from a filter with the smallest difference value, wherein whenever a filter is removed, accuracy of a network after pruning is tested, until a last filter is left, to get a testing result {acc₀, acc₁, acc₂, . . . , accₙ₋₂} of the accuracy of the network;
restoring all filters that have been removed in current convolution layer, with keeping same as the original network;
calculating difference values between the testing result {acc₀, acc₂, acc₂, . . . , accₙ₋₂} of the accuracy of the network and accuracy of the original network, to get difference values of the accuracy {acc_loss₀, acc_loss₁, acc_loss₂, . . . , acc_loss_{_n-2}}, which indicate condition of loss of network accuracy after corresponding number of filters are removed, and the greater the loss of the accuracy, the higher the sensitivity of the layer to filter removal.

8. A computer-readable medium for recording instructions that can be executed by a processor, that when executed by the processor, cause the processor to perform a method for pruning a network based on sensitivity in a Convolution Neural Network, comprising:
perform the method for performing network sensitivity analysis by pruning filters in a convolution layer in a Convolution Neural Network as in claim 4;
setting a loss threshold of model accuracy that is acceptable after pruning;
traversing all of the convolution layers except the last k convolution layers in the network, where k is any positive integer, according to sensitivity result of a convolution layer currently traversed, determining a maximum number m of filters that are removable in the layer under the condition that the loss threshold of model accuracy is not exceeded;
removing m filters of the layer with smallest sorted difference values of the feature maps;
after traversing all of the convolution layers except the last k convolution layers in the network, completing the pruning on these layers.
